(19) United States
(12) Patent Application Publication
(10) Pub. No.: US 2019/0394585 A1
(43) Pub. Date: Dec. 26, 2019

(54) HEARING DEVICE COMPRISING A LIGHT SOURCE

(71) Applicant: Sonova AG, Stafa (CH)

(72) Inventors: Erich Dittli, Reichenburg (CH); Marius Ruefenacht, Stafa (CH); Martyn Beedham, Zurich (CH)

(21) Appl. No.: 16/481,152

(22) PCT Filed: Jan. 27, 2017
(86) PCT No.: PCT/EP2017/051711

§ 371 Date: Jul. 26, 2019

(51) Int. Cl. H04R 25/00; G08B 5/36; G08B 21/18; F21V 7/00; F21V 8/00

(52) U.S. Cl. CPC H04R 25/603; H04R 25/604; H04R 25/65; G08B 5/36; H04R 2225/021; F21V 7/0008; G02B 6/0008; H04R 2225/61; G08B 21/18

(57) ABSTRACT

A hearing device including a housing for accommodating a printed circuit board and a plurality of electronic components, wherein the housing is equipped with at least one functional component, and at least one light source. The light source is disposed inside the housing such to emit light via a light guide to the outside, wherein the light guide is included by at least one of the functional devices. The proposed hearing device provides an improved luminosity even in case of being exposed to high brightness.

### TECHNICAL FIELD

The present invention is related to a hearing device according to independent claim 1.

### BACKGROUND OF THE INVENTION

Hearing devices are typically used to improve the hearing capability or communication capability of a user. A hearing device may pick up the surrounding sound with a microphone of the hearing device, process the microphone signal thereby taking into account the hearing preferences of the user of the hearing device and providing the processed sound signal into a hearing canal of the user via a miniature loudspeaker, commonly referred to as a receiver. A hearing device may also receive sound from an alternative input such as an induction coil or a wireless interface.

In the state of the art, hearing devices are known comprising at least one LED mounted in or on the housing of the hearing device. This LED can be used as a visual indicator to inform the wearer of the hearing device about the status thereof, for example battery status, hearing mode and necessary service issues, such as exchanging a microphone protection or receiver filter (cerumen protection). While said notifications could also be supplied acoustically, in some use cases the wearer needs to be supplied with a visual indication, for example if the user is not wearing the hearing device or parents want to have a confirmation about proper working status of the hearing device for their child. Document DE 10 2009 009 160 A1 describes a hearing device comprising a LED mounted on the housing of the hearing device. Document US 2011/0002491 A1 discloses a hearing device having a housing which interior surface is recessed in order to allow e.g. disposal of a light source into the recess. The housing at least in a portion of the disposed light source can be semi-transparent. This can allow that light from the light source is irradiated to the housing shell from the inside in order to be visible from the outside. In doing so, the exterior surface of the hearing device can be formed smooth.

It is a problem in the state of the art that the visual indicator, either disposed on the outside or the inside of the hearing device housing, requires a dedicated space at the hearing device housing. Further, the light source can be hardly visible once the hearing device is exposed to light, e.g. sunlight. Some designs of commonly known hearing devices suffer from impacts or at least compromises due to the placement of the light sources. Furthermore, commonly known light source placements might impact the hearing device reliability. Light source placements in commonly known hearing devices are complex, involve much space, can incur high costs and may compromise design look and feel.

It is therefore an object of the present invention to provide a hearing device solving the problems known in the state of the art.

### SUMMARY OF THE INVENTION

The present invention is directed to a hearing device which comprises a housing for accommodating a printed circuit board and a plurality of electronic components, wherein said housing is equipped with at least one functional means, and at least one light source. The light source is disposed inside the housing such to emit light via a light guide to the outside, wherein the light guide is comprised by at least one of the functional means.

Hence, the present invention provides a hearing device comprising at least one functional means which also acts as a light guide in order to guide or rather transmit light from the light source to the outside. Therefore, the functional means can involve a dual function, namely one function as functional means per se and a second function as the light guide. Hence, a hearing device with an improved visual indicator is provided.

Some of a plurality of advantages are as follows:

The light emitted from the light source provides a visual indicator which doesn't require dedicated space at the surface of the hearing device housing. Typically, it is not covered by the user's finger if the user operates the functional means or rather controls the operation of the hearing device.

The light source (and therefore the light emitted from the light source) is inside the housing of the hearing device. The housing comprises a light emitting surface which substantially is not visible at the outer surface of the hearing device. The light guide can be a hollow space which allows light from a light source inside the hearing device housing to exit through an opening at the housing of the hearing device. A bright light from the environment, e.g. sunlight, cannot reflect at the opening of the hearing device housing outer surface. Therefore, the inventive hearing device provides a visual indicator with improved contrast in case of being exposed to high brightness, e.g. exposed to sunlight.

Further, the present invention allows that the light source is completely hidden. For example, if the hearing device user does not need any light source at all, e.g. disabled by the Hearing Care Professional HCP, the user doesn't see a needless or rather disturbing element at the hearing device surface which might otherwise compromise the design of the hearing device.

The existence of the light source has no effect on the reliability of the hearing device as there is no additional opening required in the hearing device housing.

In an embodiment of the proposed hearing device the functional means is an opening formed into the housing. In this embodiment, said opening, which is a functional means, concurrently acts as the light guide in order to guide light form the inner light source to the outside.

In an embodiment, the opening is a sound canal comprising at least one of a microphone inlet and a receiver outlet. This embodiment allows a dual function of e.g. the microphone inlet as a microphone inlet per se and as the light guide in order to guide light from the light source to the outside. The same dual function applies to the receiver outlet.

In an embodiment of the proposed hearing device the opening comprises at least one of a maintenance opening and a pin insertion hole.

This pin insertion hole can be a hole configured to perceive a pin from the outside of the housing in order to actuate a push button in the interior thereof by means of the distal end of the inserted pin. The maintenance opening can allow insertion of a pin for e.g. opening the housing in the course of maintenance. In an example, the inserted pin can displace a latch such to release a latching connection.

In an embodiment of the proposed hearing device the functional means is a user control. In this embodiment, the user control involves a dual function, namely as the user control per se and as the light guide. In an embodiment, the user control comprises at least one of a switch, a button and a control dial. One of a plurality of advantages comprises that a visual indicator is provided which doesn't require a dedicated space. The user control material can be transparent or semi-transparent such that light induced from the light source into the user control (form inside the housing) is radiated or rather dispersed to the outside of the housing, e.g. on the top side of the user control or through a gap between the user control and the housing of the hearing device, such to be visible. The light can be induced into the user control directly or indirectly.

In an embodiment of the proposed hearing device the functional means is a terminal. In an embodiment, the terminal comprises a receiver connector. The receiver connector can allow to connect a receiver module via a cable to the hearing device. The receiver connector is further configured as a light guide for transmitting or dispersing light emitted by the light source from inside the housing to the outside thereof. The material of the receiver connector can at least partially comprise a semi-transparent material allowing to disperse the light such to be visible on the outside of the hearing device.

In an embodiment of the proposed hearing device the light source is mounted on the printed circuit board. Hence, space can be used more efficiently. In an example, the light source can be mounted to the printed circuit board by soldering. The inventive hearing device allows that additional tools, development costs or assembly efforts can be reduced.

In an embodiment of the proposed hearing device the light guide comprises an optical component. In an embodiment, the optical component comprises at least one of a lens, a mirror, an optical fiber, a light pipe, a reflector and a cover. In an example, a reflectivity enhancing surface treatment can be used to increase luminosity.

It is expressly pointed out that any combination of the above-mentioned embodiments is subject of further possible embodiments. Only those embodiments are excluded that would result in a contradiction.

### BRIEF DESCRIPTION OF THE DRAWINGS

The present invention is further described with reference to the accompanying drawing illustrating various exemplary embodiments which are to be considered in connection with the following detailed description. What is shown in the figure is:

FIG. 1 schematically depicts a cross-sectional view of a hearing device according to an aspect of the present invention.

### DETAILED DESCRIPTION OF THE INVENTION

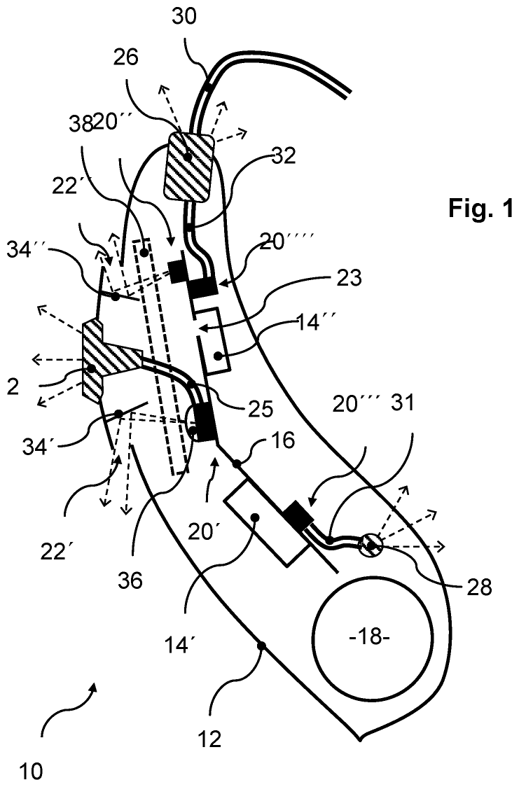

FIG. 1 schematically shows a cross sectional view of a hearing device 10 according to an aspect of the present invention. In this exemplary aspect, the hearing device 10 can be a behind-the-ear hearing device (BTE) comprising a housing 12 for accommodating a plurality of electronic components 14′,14″ which can be mounted on a printed circuit board PCB 16, e.g. by means of soldering. The electronic components 14′,14″ can comprise at least one of a processor, a controller, etc. Further comprised is a battery 18 for supplying the hearing device 10 with electric power.

The hearing device 10 further comprises a plurality of light sources 20′-20″″ disposed inside the housing 12 such to emit light via a light guide (to be described in the following) to the outside. The light sources 20′-20″″ can comprise LEDs which can be configured to indicate e.g. at least one status of the hearing device 10 to the outside, for example indicating at least one operational status of the hearing device 10, power status of the battery 18, maintenance periods, etc. or a combination thereof. In an example, at least one of the light sources 20′-20″″ can be part of an optical interface in order to allow communication to and/or from a non-shown auxiliary device, for example a battery charger, etc. In the shown example, the light sources 20′-20″″ are mounted on the printed circuit board 16, directly, e.g. by means of soldering. Therefore, manufacturing costs as well as overall size of the hearing device 10 can be reduced. While not shown, the light sources can be placed separately from the printed circuit board 16.

The hearing device 10 further comprises a plurality of functional means 22′,22″,24,26,28. Said functional means 22′,22″,24,26,28 can comprise any known or still unknown feature dedicated to e.g. a functional input and/or output. A detailed description to said functional means 22′,22″,24,26,28 will be given in the following. As mentioned above, the light sources 20′-20″″ are disposed inside the housing 12 such to emit light via the light guide to the outside. According to the invention, the light guide is comprised by at least one of the functional means 22′,22″,24,26,28.

Now, for a detailed description, reference is made to said functional means 22′,22″,24,26,28 as a whole. In an exemplary embodiment, as shown in FIG. 1, the functional means can be embodied as opening 22′,22″, wherein, in an aspect, said opening is a sound canal comprising microphone inlets 22′,22″. Said microphone inlets 22′,22″ are sound openings in the housing 12 in order to allow sound entrance from the environment to the microphone 14″ displaced inside the housing 12. Said microphone 14″ can be disposed on the printed circuit board 16 in a portion adjacent to the microphone inlets 22′,22″. In other words, the light sources 20′,20″ are disposed inside the housing 12 such to emit light thereof via light guides (as indicated by dashed arrows) which are in turn comprised by said functional means, i.e. the microphone inlets 22′,22″. Therefore, the microphone inlets 22′,22″ (which might be commonly used in order to allow sound entrance to a microphone) can also be used as light guides in order to transmit light emitted from the light sources 20′,20″ to the outside.

In an aspect, the microphone 14″ can be mounted on the bottom side of the printed circuit board 16 (e.g. by soldering). In this aspect, the printed circuit board 16 is in turn provided with a PCB opening 23 which is aligned to a microphone inlet of the microphone 14″. The term “bottom side of the printed circuit board 16” means the side of the printed circuit board 16 which is opposed to the side of sound entrance. This aspect allows that space of the printed circuit board 16 on the side of sound entrance (or rather the top side of the printed circuit board 16) can be used to be equipped with further electronic components, e.g. the light sources 20′-20″″. This aspect allows to save space or rather to increase electronic components density of the printed circuit board 16.

In the figure, the light paths extending from the light sources 20′,20″ via the respective light guides—or rather functional means 22′,22″ which are in this case embodied as the microphone inlets 22′,22″—to the outside are schematically depicted by hatched arrows. While not shown, e.g. in case of an in-the-ear hearing device (ITE), at least one opening adapted as a receiver outlet can be adapted as a light guide, as well.

As further shown, in an exemplary aspect, the light can be transmitted from at least one of the light sources 20′,20″ to the outside through the microphone inlets 22′,22″ (functional means) via at least one optical component comprising for example one or more reflectors 34′,34″. The reflectors 34′,34″ can be mounted to the user control 24 such to deflect light from the light sources 20′,20″ to the outside, as schematically depicted by deflected arrows. The light source 20′ can be provided with a lens 36 in order to adjust light beam forming and/or to provide a directional feature (light guiding). Further optical components for deflecting or rather guiding the light from the light sources 20′,20″ to the outside can comprise at least one of an optical fiber, a light pipe, a semi-transparent reflector, etc. or a combination thereof. In a further exemplary aspect, the optical component can comprise a cover 38 which can be an optically and acoustically transparent filter element placed between the light sources 20′,20″ and the microphone inlet 22′,22″. Said cover 36 can be adapted to protect the microphone 14″ and/or the light sources 20′,20″ against entrance of e.g. moisture, dirt, dust, etc. In this exemplary aspect, provision of a dedicated optical fiber can be omitted.

As further shown in the figure, one of the functional means can be embodied as a user control 24, which can be a shift button, press button, control dial, etc. In this example, the user control 24 (configured as the functional means) also comprises a light guide used to transmit light emitted from the light source 20′ to the outside. The term “the user control 24 comprises a light guide” means that the user control 24 is adapted to transmit light, which is directly or indirectly induced from one part of the user control 24, to at least one further part thereof. In doing so, the user control 24 body can comprise a transparent or semi-transparent material. In the shown example, the light induced from the light source 20′ into the user control 24 on the bottom side thereof is transmitted through the user control 24 body and is dispersed to the outside on the top side thereof, as indicated by dashed arrows. The material of the user control 24 can at least partially comprise a semi-transparent material allowing to disperse light introduced from the light source 20′ to the outside such to be visible. The light of the light source 20′ can be induced into the user control 24 directly by means of a fiber optic 25. While not shown, the light can be induced indirectly, for example the light could reach the user control through reflections.

In the shown example, the light source 20′ is adapted to emit light via the sound inlet 22′ as well as via the user control 24. This exemplary light source 20′ can be controlled to output light unitary or separated. It is to be noted that more than one light source, i.e. separate light sources, can be used to emit light via the microphone inlets 22′ and the user control 24, separately.

Further, in the aspect as shown in FIG. 1, the functional means can be a pin insertion hole 28 formed into the housing 12. This pin insertion hole 28 can be provided in order to allow insertion of a pin (not shown) from the outside of the housing 12 into the interior thereof in order to actuate a (miniaturized) push button by means of the distal end of the pin. In another example of the aspect, said functional means can comprise a maintenance opening allowing to insert a pin for e.g. opening the housing 12 due to maintenance. In the aspects mentioned above, the pin insertion hole 28 (embodied as a functional means) also acts as a light guide in order to transmit light emitted from the light source 20′″ to the outside as schematically depicted by hatched arrows in the figure. In an aspect, the light emitted from the light source 20′″ can be guided to the pin insertion hole 28 by means of an optical fiber means 31, directly. While not shown, the light can be passed indirectly. The pin insertion hole may itself comprise a pin made of a transparent material, the pin acting as a light guide.

In a further example of the shown aspect, the receiver connector 26 which (as a functional means) can be broadly used as a terminal in order to connect a receiver module (not shown) via a cable 30 to the hearing device 10, is configured as a light guide for transmitting or rather dispersing light emitted by the light source 20″″ to the outside as schematically depicted by hatched arrows. In this aspect, the light can be passed from the light source 20″″ to the receiver connector 26 directly via an optical fiber means 32. While not shown, the light can be passed indirectly. The material of the receiver connector 26 can at least partially comprise a transparent or semi-transparent material allowing to disperse light introduced from the light source 20″″ to the outside such to be visible even in the case of a bright environment, e.g. sunlight.

The inventive hearing device 10 allows that additional openings in the housing 12 can be omitted. In other words, the existence of the light sources 20′-20″″ has no effect on the reliability of the hearing device 10, since the provision of additional openings in the housing 12 can be omitted. Further, the light sources 20′-20″″ are “hidden” by the housing 12 and can therefore not be regarded as a disturbing element at the outer surface of the housing 12. This results in a more pleased design for the user. Further, bright light from the environment irradiating the hearing device 10, for example sunlight, does not diminish the contrast of the light emitted by the light sources 20′-20″″ via the light guides to the outside, wherein the light guides are comprised by the functional means. In other words, contrast of the visual indicator of the inventive hearing device 10 is improved.

What is claimed is:

1. A hearing device (10) comprising:
a housing (12) for accommodating a printed circuit board (16) and a plurality of electronic components (14′-14″), wherein said housing (12) is equipped with at least one functional means (22′,22″,24,26,28); and
at least one light source (20′-20″″),
wherein the light source (20′-20″″) is disposed inside the housing (12) such to emit light via a light guide to the outside, wherein the light guide is comprised by at least one of the functional means (22′,22″,24,26,28).

2. The hearing device (10) according to claim 1, wherein the functional means is an opening (22′,22″) formed into the housing (12).

3. The hearing device (10) according to claim 2, wherein the opening (22′,22″) is a sound canal comprising at least one of a microphone inlet (22′,22″) and a receiver outlet.

4. The hearing device (10) according to claim 2, wherein the opening comprises at least one of a maintenance opening and a pin insertion hole (28).

5. The hearing device (10) according to claim 1, wherein the functional means is a user control (24).

6. The hearing device (10) according to claim 5, wherein the user control comprises at least one of a switch, a button (24) and a control dial.

7. The hearing device (10) according to claim 1, wherein the functional means is a terminal (26).

8. The hearing device (10) according to claim 7, wherein the terminal (26) comprises a receiver connector (26).

9. The hearing device (10) according to claim 1, wherein the light source (20′-20″″) is mounted on the printed circuit board (16).

10. The hearing device (10) according to claim 1, wherein the light guide comprises an optical component (25,31,32,34′,34″,36,38).

11. The hearing device (10) according to claim 10, wherein the optical component comprises at least one of a lens (36), a mirror, an optical fiber (25,31,32), a light pipe, a reflector (34′,34″) and a cover (38).
